(19) United States
(12) Patent Application Publication
(10) Pub. No.: US 2020/0180043 A1
(43) Pub. Date: Jun. 11, 2020

(54) PRECISION SECURING DEVICE

(71) Applicant: Stamford Precision Tools Pte Ltd, Singapore (SG)

(72) Inventor: Seng Haw YEO, Singapore (SG)

(21) Appl. No.: 16/623,371

(22) PCT Filed: Jun. 18, 2018
(86) PCT No.: PCT/SG2018/050297

§ 371 Date: Dec. 16, 2019

(30) Foreign Application Priority Data
Jun. 16, 2017 (SG) 10201705006W

(51) Int. Cl. B23B 31/20; B23Q 3/12

(52) U.S. Cl. CPC B23B 31/202; B23B 31/005; B23Q 3/12

(57) ABSTRACT

A precision securing device is disclosed that comprises a central longitudinal hole to receive a shaft from a first end of the device, a gripping portion around the central hole to fixedly secure an upper part of the shaft, and an adjustment portion around the central hole adjacent the first end. The adjustment portion has a number of lateral adjustment holes opening into the central hole. Each adjustment hole is threaded to receive an adjustment screw into the central hole to contact a lower part of the shaft in the central hole. A first diameter of the central hole at the adjustment portion is larger than a second diameter at the gripping portion. Runout of the shaft is adjustable by adjusting depth of entry of each screw to displace the lower part of the shaft when the upper part has been fixedly secured in the gripping portion.

### FIELD

This invention relates to a device for securing tools with precision.

### BACKGROUND

In precision machining, it is extremely important that a rotary cutting tool such as a drill bit or reamer is positioned with accuracy and precision in order to achieve the extremely close tolerances required on the workpiece. Currently, achieving such accuracy and precision requires manual adjustment of the tool after it has already been secured to a machine to spin the tool, by appropriately applying external forces on the secured tool while it is slowly rotated against an indicator that gives output of concentricity or runout tolerance of the slowly rotating cutting tool. Applying external forces on the secured tool is usually carried out by manually knocking or tapping on the tool with a light hammer while it is slowly rotated, in response to the output of the indicator (commonly a dial or digital indicator). However, achieving accuracy and precision this way requires significant skill and experience from the human operator performing the manual adjustment. This increases production costs as only highly skilled persons can be employed to perform the task. Also, the number of rejected parts becomes dependent on the skill of the person adjusting the tool prior to cutting, resulting in a lower level of quality control than would be desired.

### SUMMARY

According to a first aspect, there is provided a precision securing device, the device comprising: a central longitudinal hole to receive a shaft therein from a first end of the device; a gripping portion around the central longitudinal hole to fixedly secure an upper part of the shaft therein; and an adjustment portion around the central longitudinal hole adjacent the first end of the device, the adjustment portion having a number of lateral adjustment holes opening into the central longitudinal hole, each of the adjustment holes being threaded to receive and allow passage of an adjustment screw into the central longitudinal hole to contact a lower part of the shaft in the central longitudinal hole; wherein a first diameter of the central longitudinal hole at the adjustment portion is larger than a second diameter of the central longitudinal hole at the gripping portion, and wherein runout of the shaft when secured to the device is adjustable by adjusting depth of entry of each adjustment screw into the central longitudinal hole to displace the lower part of the shaft when the upper part of the shaft has been fixedly secured in the gripping portion.

The central longitudinal hole may be a through hole, the adjustment portion may be formed by a first wall of the device and the gripping portion may be formed by a gripping part of a second wall of the device, the first wall being thicker than the second wall, the second wall may be configured to fit into a collet, and the shaft may be a shank of a rotary cutting tool.

The first diameter of the central through hole may extend from the first wall to a non-gripping part of the second wall, the non-gripping part being between the adjustment portion and the gripping part of the second wall.

The second wall may comprise a number of longitudinal through slits opening into the central longitudinal hole, the longitudinal through slits allowing the gripping part to be compressed around the upper part of the shaft to immovably grip the upper part of the shaft.

A first end of each of the longitudinal through slits may terminate at the non-gripping part and the longitudinal through slits may extend through a second end of the device.

Alternatively, each of the longitudinal through slits may have a second end terminating before a second end of the device.

The second wall may comprise an extension at a second end of the device, the extension extending beyond the shaft when the upper part of the shaft has been fixedly secured in the gripping portion. The first ends of the longitudinal through slits may terminate at the non-gripping part and the second ends of the longitudinal through slits may terminate at the extension. Alternatively, the number of longitudinal through slits may be provided as a first set of longitudinal through slits and a second set of longitudinal through slits, each of the first set of longitudinal through slits having a first end terminating at the non-gripping part and a second end terminating at the gripping part, and each of the second set of longitudinal through slits having a first end terminating at the gripping part and a second end terminating at the extension.

External diameter of the extension may be smaller than external diameter of the gripping portion.

The device may further comprise a thinned portion provided around the non-gripping part to allow sufficient flexing of the gripping part to immovably grip the upper part of the shaft and fixedly secure the upper part of the shaft in the gripping portion.

The gripping portion may have a number of lateral gripping holes opening into the central longitudinal hole, each of the gripping holes being threaded to receive and allow passage of a gripping screw into the central longitudinal hole to contact the upper part of the shaft in the central longitudinal hole to fixedly secure the upper part of the shaft in the gripping portion.

The lateral gripping holes may be angled upwards into the central longitudinal hole.

The shaft may comprise a shank of a rotary cutting tool and the device may comprise an extension holder to extend reach of the rotary cutting tool into a workpiece.

Alternatively, the shaft may comprise an arbor and the device may comprise an adaptor to connect the arbor to a spindle.

### BRIEF DESCRIPTION OF FIGURES

In order that the invention may be fully understood and readily put into practical effect there shall now be described by way of non-limitative example only exemplary embodiments of the present invention, the description being with reference to the accompanying illustrative drawings.

FIG. 1 is a perspective view of a first variation of a first exemplary embodiment of the precision securing device.

FIG. 2 is an end view of a first end of the device of FIG. 1.

FIG. 3 is a side view of the device of FIG. 1.

FIG. 4 is a perspective view of a second variation of a first exemplary embodiment of the precision securing device.

FIG. 5 is an end view of a first end of the device of FIG. 4.

FIG. 6 is a side view of the device of FIG. 4.

FIG. 7 is a perspective view of a third variation of a first exemplary embodiment of the precision securing device.

FIG. 8 is an end view of a first end of the device of FIG. 7.

FIG. 9 is a side view of the device of FIG. 7.

FIG. 10 is a side view of a second exemplary embodiment of the precision securing device.

FIG. 11 is a close-up side view of portion X of the device in FIG. 10.

FIG. 12 is a side view of a rotary cutting tool for use with the device of FIG. 10.

FIG. 13 is a close-up side assembly view of the device of FIG. 11 and the rotary cutting tool of FIG. 12.

FIG. 14 is a side view of a third exemplary embodiment of the precision securing device.

FIG. 15 is an end view of a first end of the device of FIG. 14.

FIG. 16 is a side view of an arbor for use with the device of FIG. 14.

### DETAILED DESCRIPTION

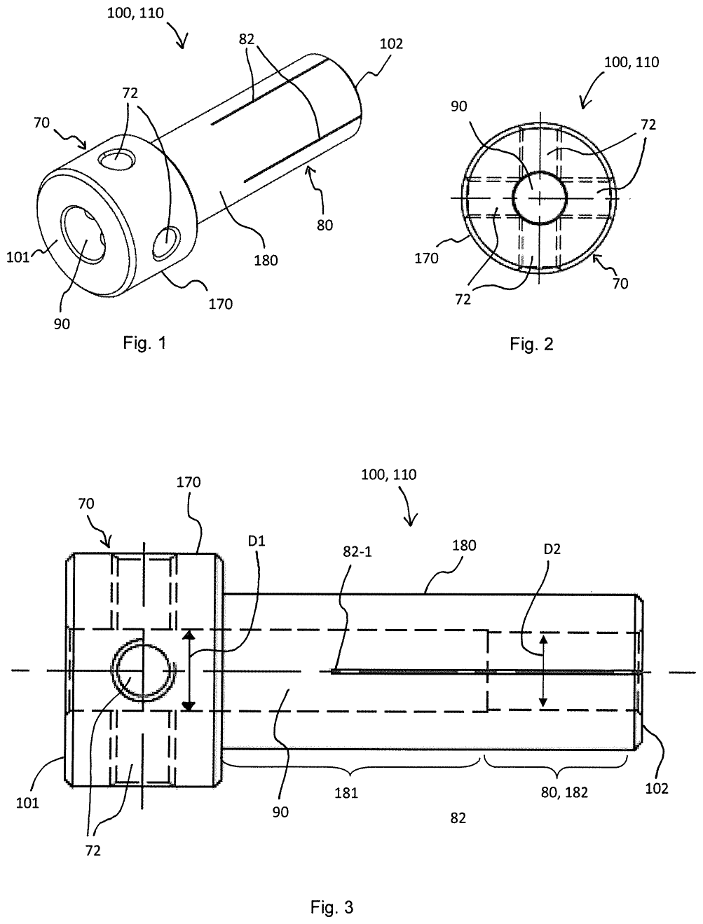

Exemplary embodiments and variations of a precision securing device 100 will be described below with reference to FIGS. 1 to 16. The same reference numerals are used in the different figures to denote the same or similar parts.

In general, for all embodiments and variations as shown in FIGS. 1 to 11 and 13 to 15, the precision securing device 100 comprises a central longitudinal hole 90 to receive a shaft therein from a first end 101 of the device 100.

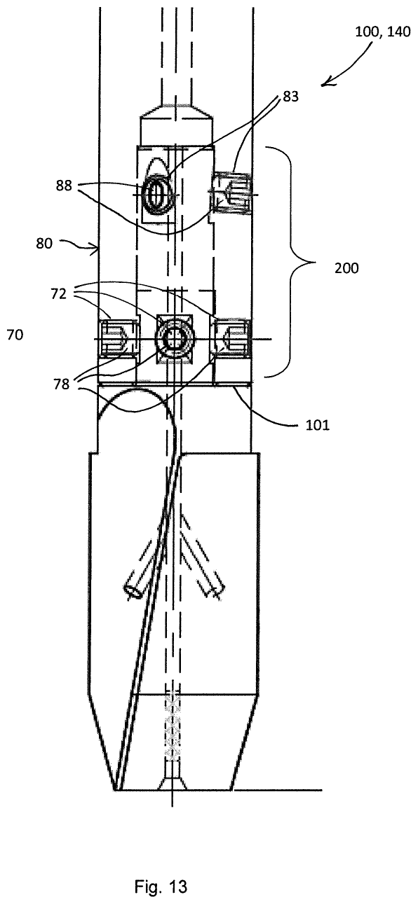

For the first and second embodiments shown in FIGS. 1 to 11, the shaft may comprise a shank of a rotary cutting tool such as a drill bit, a reamer or an end mill as shown in FIGS. 12 and 13.

FIGS. 1 to 9 show the device 100 in different variations of a first exemplary embodiment as an adjustable collet sleeve 110, 120, 130 to connect the rotary cutting tool (not shown) to a collet (not shown).

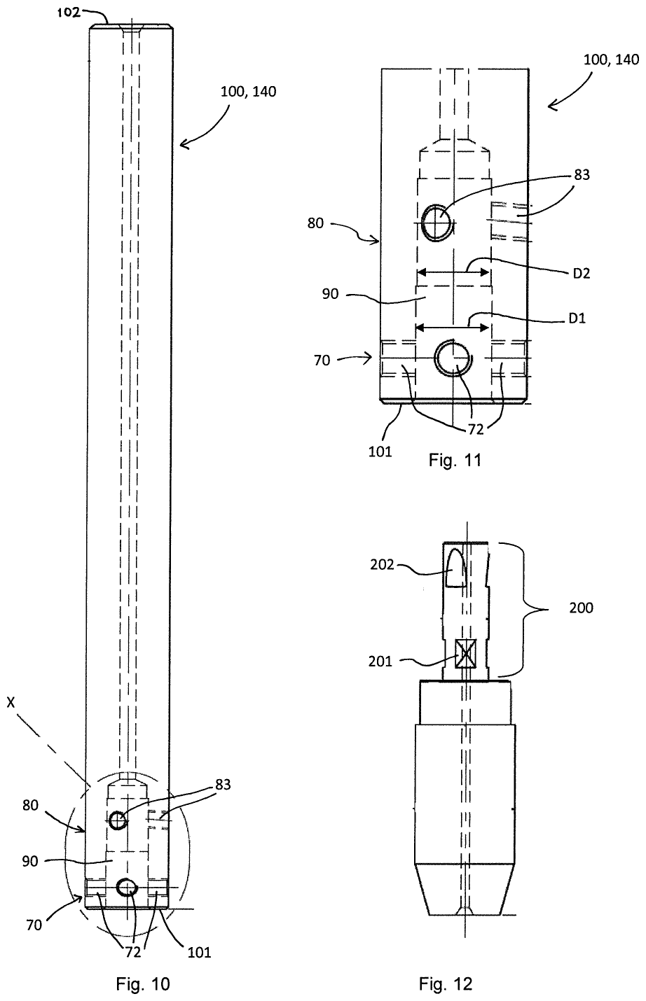

FIGS. 10, 11 and 13 show the device 100 in a second exemplary embodiment as an extension holder 140 that is attached to a collet (not shown) to extend reach of the rotary cutting tool into a workpiece (not shown).

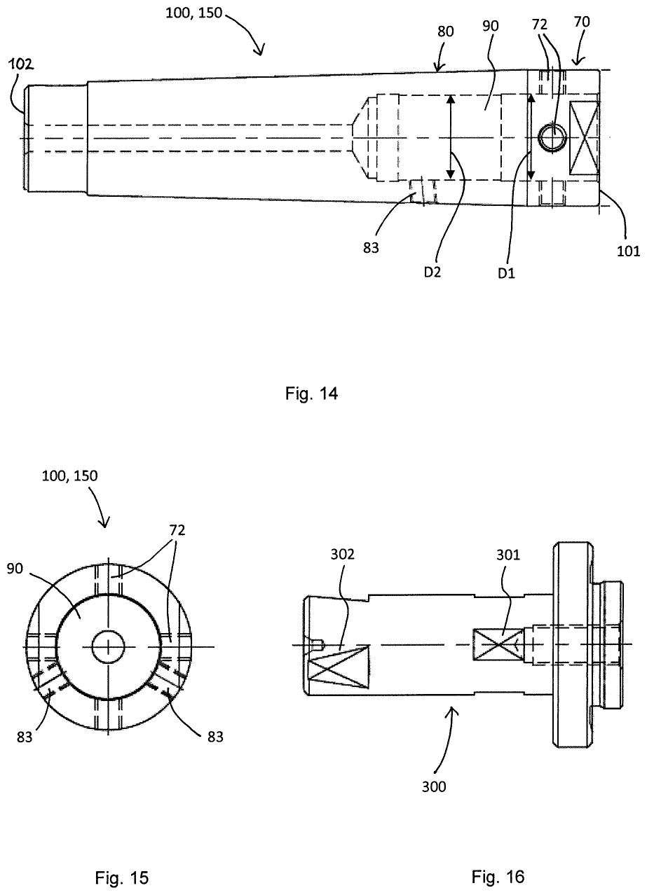

In the third exemplary embodiment shown in FIGS. 14 and 15, the shaft may comprise part of an arbor 300 as shown in FIG. 16, and the device 150 is embodied as an adaptor for the arbor 300, for example, to connect the arbor 300 to a spindle (not shown).

The different embodiments and variations of the device 100 will be described in greater detail below in their respective sections.

### All Embodiments

For all embodiments, the device 100 comprises a gripping portion 80 around the central longitudinal hole 90 to fixedly secure an upper part of the shaft therein. The device 100 also comprises an adjustment portion 70 around the central longitudinal hole 90 adjacent the first end 101 of the device 100. The adjustment portion 70 has a number of lateral adjustment holes 72 opening into the central longitudinal hole 90. Each of the adjustment holes 72 is threaded to receive and allow passage of an adjustment screw (not shown) into the central longitudinal hole 90 to contact a lower part of the shaft in the central longitudinal hole 90.

A first diameter D1 of the central longitudinal hole 90 at the adjustment portion 70 is larger than a second diameter D2 of the central longitudinal hole 90 at the gripping portion 80. The second diameter D2 is sized to have a sliding fit with the upper part of the shaft that will be fixedly secured in the device 100. In this way, when the shaft has been inserted into the longitudinal hole 90 and the upper part of the shaft has been fixedly secured in the gripping portion 80, the lower part of the shaft still has room to move within the larger diameter D1 of the central longitudinal hole 90 at the adjustment portion 70. This room to move allows runout of the shaft to be adjusted by adjusting depth of entry of each adjustment screw into the central longitudinal hole 90 against the lower part of the shaft. Adjusting the depth of entry of the adjustment screws allows very fine displacement of the lower part of the shaft to be made when the upper part of the shaft has been fixedly secured in the gripping portion 80, thereby allowing runout of the shaft to be minimized.

Preferably, the adjustment portion 70 has four adjustment holes 72 that are orthogonally angled apart from each other, as shown in FIGS. 2, 5, 8 and 15. This allows runout of the shaft to be more easily minimized by selectably adjusting one or more of the adjustment screws in response to output of an indicator against which the shaft is slowly rotated during adjustment.

### First Exemplary Embodiment: Collet Sleeve

For all embodiments of the device 100 as a collet sleeve 110, 120, 130, as shown in FIGS. 1 to 9, the central longitudinal hole 90 is a through hole. The collet sleeve 110, 120, 130 generally comprises a first wall 170 and a second wall 180. The two walls 170, 180 are preferably integrally formed from one solid piece of metal.

The adjustment portion 70 is formed by the first wall 170 and the gripping portion 80 is formed by a gripping part 182 of the second wall 180. The first wall 170 is thicker than the second wall 180 in order to provide sufficient strength and stability to keep a rotary cutting tool secured in the device 100 in its adjusted position (i.e. when runout has been minimized) via the adjustment screws after adjustment has been performed. The second wall 180 is configured to fit into a collet. In this way, the collet sleeve 110, 120, 130 allows a rotary cutting tool to be securely attached to a collet while allowing runout of the rotary cutting tool to be easily minimized.

The first diameter D1 of the central through hole 90 preferably extends from the first wall 170 to a non-gripping part 181 of the second wall 180, as can be seen in FIGS. 3, 6 and 9. The non-gripping part 181 is located between the adjustment portion 70 and the gripping part 182 of the second wall 180.

The second wall 180 comprises a number of longitudinal through slits 82 opening into the central longitudinal hole 90. At least some of the longitudinal through slits 82 preferably have a first end 82-1, 84-1 terminating at the non-gripping part 181 in order to allow the gripping part 182 to be compressed around an upper part of a shank of a rotary cutting tool (not shown) to immovably grip the upper part of the shank. The longitudinal through slits 82 are preferably equally spaced apart from each other for even compression around the upper part of the shank.

In use, the second wall 180 of the collet sleeve 110, 120, 130 is inserted into a collet and the shank of a rotary cutter is inserted into the collet sleeve 110, 120, 130 from the first end 101 of the collet sleeve 110, 120, 130. Tightening of the collet around the second wall 180 results in the gripping part 182 being compressed around the upper part of the shank. This compression fixedly secures the upper part of the shank in the gripping portion 80 of the collet sleeve 110, 120, 130, and also fixedly secures the collet sleeve 110, 120, 130 to the collet.

First Variation of Collet Sleeve—Basic Type

In a first variation of the collet sleeve 110 as shown in FIGS. 1 to 3, a first end 82-1 of all the longitudinal through slits 82 terminate at the non-gripping part 181 of the second wall 180. All the longitudinal through slits 82 extend through a second end 102 of the collet sleeve 110, so that the second end 102 of the collet sleeve 110 is split by the longitudinal through slits 82.

Second Variation of Collet Sleeve—External Coolant Type

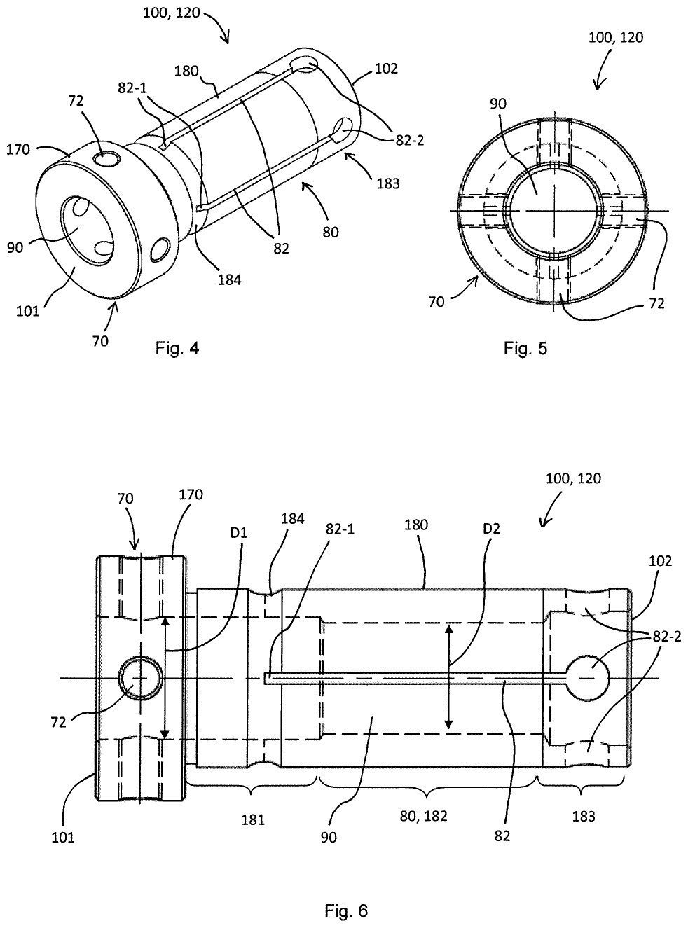

In a second variation of the collet sleeve 120 as shown in FIGS. 4 to 6, all the longitudinal through slits 82 each have a first end 82-1 terminating at the non-gripping part 181. The second wall 180 at the second end 102 of the collet sleeve 120 comprises a closed circular wall because a second end 82-2 of each of all the longitudinal through slits 82 terminate before the second end 102 of the collet sleeve 120. The closed circular wall at the second end 102 of the collet sleeve 120 helps to maintain circularity of the second wall 180.

The second wall 180 preferably comprises a thinned portion 184 provided around the non-gripping part 181 to allow sufficient flexing of the gripping part 182 for compression by a collet around the upper part of the shaft and fixedly secure the upper part of the shaft in the gripping portion 80. The first ends 82-1 of the longitudinal through slits 82 preferably terminate at the thinned portion 184. The thinned portion 184 may be formed by forming a groove into the exterior surface of the second wall 180 around the non-gripping part 181.

Preferably, the second wall 180 also comprises an extension 183 at the second end 102 of the collet 120. The extension 183 extends beyond the shank of a rotary cutting tool when the upper part of the shank has been fixedly secured in the gripping portion 80. External diameter of the extension 183 is preferably smaller than external diameter of the gripping portion 182 to allow easy entry of the collet sleeve 120 into a collet, and also to allow sufficient compression of the gripping part 182 around the upper part of the shaft by the collet in order to fixedly secure the upper part of the shaft in the gripping portion 80.

The second ends 82-2 of the longitudinal through slits 82 preferably terminate at the extension 183. In this way, when the rotary cutting tool has been secured in the collet sleeve 120, coolant (not shown) that is flowed into the central longitudinal hole 90 via the second end 102 of the collet sleeve 120 is able to flow out of the central longitudinal hole 90 through the second ends 82-2 of the longitudinal through slits 82, down the longitudinal through slits 82, and into the central longitudinal hole 90 again at the non-gripping portion 181 through the first ends 82-1 of the longitudinal through slits. Coolant is not able to flow in the central longitudinal hole 90 at the gripping portion 80 between the upper part of the shank and the gripping part 182 because the second wall 180 has been compressed so that the gripping part 182 is in tight contact with the upper part of the shank without room for coolant flow therebetween.

Coolant that has entered the central longitudinal hole 90 at the non-gripping part 181 is able to flow down the central longitudinal hole 90 through the adjustment portion 70 to coat the exterior of the rotary cutting tool due to the enlarged first diameter D1 of the central longitudinal hole 90 providing a clearance with the lower part of the shank of the rotary cutting tool at the adjustment portion 70. In this way, the second variation of the collet sleeve 120 is compatible for use with rotary cutting tools that use an external coolant during cutting.

Third Variation of Collet Sleeve—Internal Coolant Type

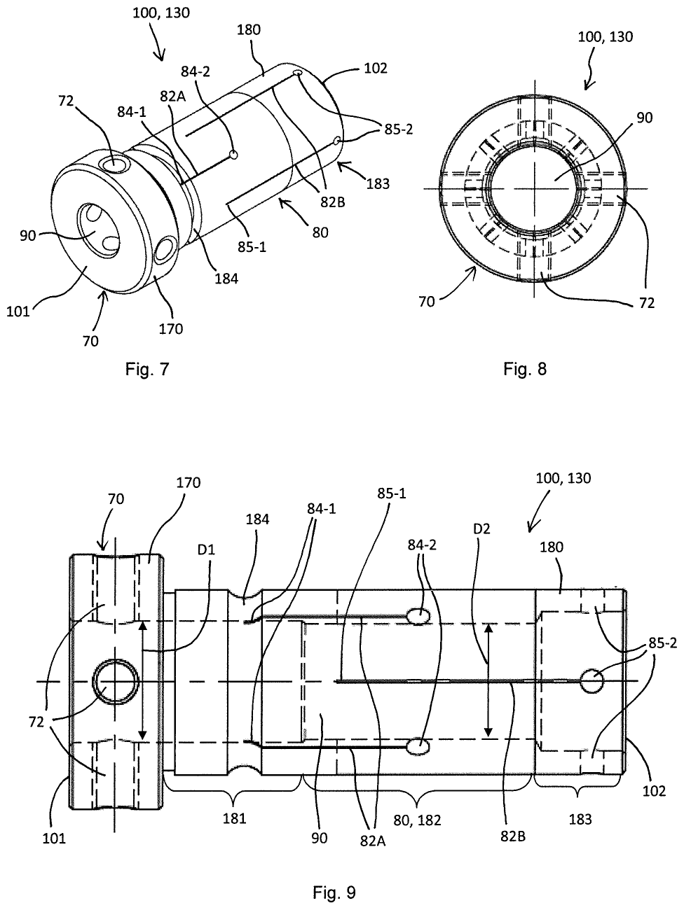

In a third variation of the collet sleeve 130 as shown in FIGS. 7 to 9, two sets of longitudinal through slits 82A, 82B are provided. The two sets of longitudinal through slits 82A, 82B are preferably provided in an alternating configuration and equally spaced apart around the second wall 180 for even compression of the gripping part 182 around the upper part of the shank in the gripping portion 80. Each set 82A, 82B preferably comprises four longitudinal through slits.

The first set of longitudinal through slits 82A each preferably have a first end 84-1 terminating at the non-gripping part 181 and a second end 84-2 terminating at the gripping part 182 to allow compressing of the gripping part 182 around the upper part of a shank of a rotary cutting tool.

The second set of longitudinal through slits 82B each preferably have a first end 85-1 terminating at the gripping part 182 and a second end 85-2 terminating at an extension 183 of the second wall 180 at the second end 102 of the collet 130. The extension 183 extends beyond the shank of a rotary cutting tool when the upper part of the shank has been fixedly secured in the gripping portion 80. External diameter of the extension 183 is preferably smaller than external diameter of the gripping portion 182 to allow easy entry of the collet sleeve 120 into a collet, and also to allow sufficient compression of the gripping part 182 around the upper part of the shaft by the collet in order to fixedly secure the upper part of the shaft in the gripping portion 80.

The second end 102 of the collet sleeve 130 comprises a closed circular wall because the second ends 84-2, 85-2 of all the longitudinal through slits 82 terminate before the second end 102 of the collet sleeve 130, thereby helping to maintain circularity of the second wall 180.

The second wall 180 preferably also comprises a thinned portion 184 provided around the non-gripping part 181 to allow sufficient flexing of the gripping part 182 to immovably grip the upper part of the shank in the gripping portion 80. The first ends 84-1 of the first set of longitudinal through slits 82A preferbaly terminate at the thinned portion 184. The thinned portion 184 may be formed by forming a groove into the exterior surface of the second wall 180 around the non-gripping part 181.

When a rotary cutting tool that has an internal coolant supply channel has been secured in the collet sleeve 130, coolant (not shown) that is flowed into the central longitudinal hole 90 via the second end 102 of the collet sleeve 130 will flow mainly into the internal coolant supply channel at the shank of the rotary cutting tool in the central longitudinal hole 90 and out at the cutting end of the rotary cutting tool.

Although some coolant that is flowed into the central longitudinal hole 90 via the second end 102 of the collet sleeve 130 is able to flow out through the second ends 85-2 of the second set of longitudinal through slits 82B and down the second set of longitudinal through slits 82B, such coolant will not be able to enter the central longitudinal hole 90 again because the first ends 85-1 of the second set of longitudinal through slits 82B terminate at the gripping part 182 that is in tight contact with the upper part of the shank without room for coolant flow therebetween.

Furthermore, the second ends 84-2 of the first set of longitudinal through slits 82A also terminate at the gripping portion 182 where there is no room for coolant to flow out from the central longitudinal hole 90 through the second ends 84-2. In this way, coolant is kept away from the exterior of the rotary cutting tool, so that the third variation of the collet sleeve 130 is compatible for use with rotary cutting tools that have an internal coolant supply channel for supplying coolant internally to the cutting end.

### Second Exemplary Embodiment: Extension Holder

In the second exemplary embodiment of the device 100 as an extension holder 140, as shown in FIGS. 10, 11 and 13, the gripping portion 80 has a number of lateral gripping holes 83 opening into the central longitudinal hole 90. Each of the gripping holes 83 is threaded to receive and allow passage of a gripping screw 88 (FIG. 13) into the central longitudinal hole 90 to contact the upper part 202 of a shank 200 of rotary cutting tool in the central longitudinal hole 90. Preferably, the gripping holes 83 are equally spaced apart from each other around the gripping portion 80 for even securing of the upper part of the shank 202. The number of gripping holes 83 provided may be three or more, depending on the diameter of the extension holder 140.

The lateral gripping holes 83 are preferably angled upwards into the central longitudinal hole when the extension holder 140 is oriented with its first end 101 facing down and second end 102 facing up. This is to increase upward force and grip of the gripping screws 88 against the upper part 202 of the shank 200.

As shown in FIGS. 12 and 13, the upper part 202 and lower part 201 of the shank 200 preferably comprise flat surfaces for better contact and fixing by the gripping screws 88 and the adjustment screws 78 respectively.

### Third Exemplary Embodiment: Adaptor for Abor

In the third exemplary embodiment of the device 100 as an adaptor 150 for an arbor 300, as shown in FIGS. 14 to 15, the gripping portion 80 has a number of lateral gripping holes 83 opening into the central longitudinal hole 90. Each of the gripping holes 83 is threaded to receive and allow passage of a gripping screw (not shown) into the central longitudinal hole 90 to contact the upper part 302 of the arbor 300 in the central longitudinal hole 90. Preferably, the gripping holes 83 are equally spaced apart from each other around the gripping portion 80 for even securing of the upper part of the arbor 300.

The lateral gripping holes 83 are preferably angled upwards into the central longitudinal hole when the adaptor 150 is oriented with its first end 101 facing down and second end 102 facing up. This is to increase upward force and grip of the gripping screws against the upper part 302 of the arbor 300.

As shown in FIG. 16, the upper part 302 and lower part 301 of the arbor 300 preferably comprise flat surfaces for better contact and fixing by the gripping screws and the adjustment screws respectively.

Using the above-described device 100, it will be appreciated that instead of having to apply knocking or tapping forces on the shaft in order to minimize runout when securing tools and tool holders to a spindle, runout can now be easily and controllably minimized simply by adjusting the adjustment screws against the lower part of the shaft in the device. This removes the need for skill and experience from the human operator performing the adjustment, compared to the prior art knocking or tapping method that provides little control over the actual displacement achieved by the knocks or taps. The final adjustment can also be expected to be better as finer displacement can be achieved by controlling adjustment of the screws compared to merely knocking against the shaft with a hammer.

Whilst there has been described in the foregoing description exemplary embodiments of the present invention, it will be understood by those skilled in the technology concerned that many variations and combination in details of design, construction and/or operation may be made without departing from the present invention. For example, it will be appreciated that features that are found in only certain embodiments or variations may also be provided as alternatives in the other embodiments or variations, so that all the features described above may be mixed or combined in myriad different ways in other embodiments of the device that may be envisaged.

1. A precision securing device, the device comprising:
a central longitudinal hole to receive a shaft therein from a first end of the device;
a gripping portion around the central longitudinal hole to fixedly secure an upper part of the shaft therein; and
an adjustment portion around the central longitudinal hole adjacent the first end of the device, the adjustment portion having a number of lateral adjustment holes opening into the central longitudinal hole, each of the adjustment holes being threaded to receive and allow passage of an adjustment screw into the central longitudinal hole to contact a lower part of the shaft in the central longitudinal hole;
wherein a first diameter of the central longitudinal hole at the adjustment portion is larger than a second diameter of the central longitudinal hole at the gripping portion, and
wherein runout of the shaft when secured to the device is adjustable by adjusting depth of entry of each adjustment screw into the central longitudinal hole to displace the lower part of the shaft when the upper part of the shaft has been fixedly secured in the gripping portion.

2. The device of claim 1, wherein the central longitudinal hole is a through hole, wherein the adjustment portion is formed by a first wall of the device and the gripping portion is formed by a gripping part of a second wall of the device, the first wall being thicker than the second wall, wherein the second wall is configured to fit into a collet, and wherein the shaft is a shank of a rotary cutting tool.

3. The device of claim 2, wherein the first diameter of the central through hole extends from the first wall to a non-gripping part of the second wall, the non-gripping part being between the adjustment portion and the gripping part of the second wall.

4. The device of claim 3, wherein the second wall comprises a number of longitudinal through slits opening into the central longitudinal hole, the longitudinal through slits allowing the gripping part to be compressed around the upper part of the shaft to immovably grip the upper part of the shaft.

5. The device of claim 4, wherein a first end of each of the longitudinal through slits terminates at the non-gripping part and the longitudinal through slits extend through a second end of the device.

6. The device of claim 4, wherein each of the longitudinal through slits has a second end terminating before a second end of the device.

7. The device of claim 6, wherein the second wall comprises an extension at a second end of the device, the extension extending beyond the shaft when the upper part of the shaft has been fixedly secured in the gripping portion, and wherein the first ends of the longitudinal through slits terminate at the non-gripping part and the second ends of the longitudinal through slits terminate at the extension.

8. The device of claim 6, wherein the second wall comprises an extension at a second end of the device, the extension extending beyond the shaft when the upper part of the shaft has been fixedly secured in the gripping portion, wherein the number of longitudinal through slits are provided as a first set of longitudinal through slits and a second set of longitudinal through slits, each of the first set of longitudinal through slits having a first end terminating at the non-gripping part and a second end terminating at the gripping part, and each of the second set of longitudinal through slits having a first end terminating at the gripping part and a second end terminating at the extension.

9. The device of claim 7, wherein external diameter of the extension is smaller than external diameter of the gripping portion.

10. The device of claim 4, further comprising a thinned portion provided around the non-gripping part to allow sufficient flexing of the gripping part to immovably grip the upper part of the shaft and fixedly secure the upper part of the shaft in the gripping portion.

11. The device of claim 1, wherein the gripping portion has a number of lateral gripping holes opening into the central longitudinal hole, each of the gripping holes being threaded to receive and allow passage of a gripping screw into the central longitudinal hole to contact the upper part of the shaft in the central longitudinal hole to fixedly secure the upper part of the shaft in the gripping portion.

12. The device of claim 11, wherein the lateral gripping holes are angled upwards into the central longitudinal hole.

13. The device of claim 11, wherein the shaft comprises a shank of a rotary cutting tool and wherein the device comprises an extension holder to extend reach of the rotary cutting tool into a workpiece.

14. The device of claim 11, wherein the shaft comprises an arbor and wherein the device comprises an adaptor to connect the arbor to a spindle.
